(19) United States
(12) Patent Application Publication
(10) Pub. No.: US 2013/0175808 A1
(43) Pub. Date: Jul. 11, 2013

(54) WATER COLUMN GENERATOR FOR GENERATING ELECTRICITY

(71) Applicant: Richard P. Palmeri, North Palm Beach, FL (US)

(72) Inventor: Richard P. Palmeri, North Palm Beach, FL (US)

(21) Appl. No.: 13/825,408

(22) PCT Filed: Sep. 23, 2011
(86) PCT No.: PCT/US11/52927

§ 371 Date: Mar. 21, 2013

Related U.S. Application Data
(60) Provisional application No. 61/404,082, filed on Sep. 27, 2010.

(51) Int. Cl. F03B 13/10

(52) U.S. Cl. CPC F03B 13/10; F03B 17/04
USPC 290/1 R; 74/DIG. 9

(57) ABSTRACT

A closed system column generator having a container for holding a fluid having a first end and a second end. A traveler reciprocally traveling along a travel path between the first end and the second end of the container. The traveler exhibits a positive buoyancy and negative buoyancy as a function of a position and direction of travel along the travel path. At least one generator disposed along the travel path, operatively connected to the traveler, to generate electricity as a function of movement of the traveler along the travel path at a position proximate to the generator.

### CROSS-REFERENCE TO RELATED APPLICATIONS

This application claims priority to U.S. Provisional Patent Application No. 61/404,082, filed on Sep. 27, 2010, in the entirety and is hereby incorporated by reference.

### BACKGROUND OF THE INVENTION

This invention is directed to the creation of hydroelectric power, and more particularly, the use of a reciprocating motion within a column of water to power mechanical generators to create electricity.

There are many conventional ways to create electric power, or to drive a motor, including the burning of fossil fuels to drive a turbine to turn a rotor to work with the stator to create electricity. This conventional method of producing energy has been used for over a century. However, it suffers from the shortcoming that it creates pollution including greenhouse gases, requires a vanishing resource for burning, and is subject to the whims of supplies such as embargoes, price fluctuations, temporary shortages, supply line disruptions, and the like.

Alternative energy sources such as wind turbines, solar power cells and nuclear energy have also been developed, all of which convert one type of energy into electrical energy or directly drive a motor. These energy sources have been satisfactory, however these suffer from the respective shortcomings that they are relatively inefficient and require significant storage capacity as there is not always wind or sunshine. As a result, energy can only be generated at limited times and in limited geographical areas. Furthermore, although nuclear energy is substantially clean during use, there are substantial issues with the waste product; where to store them and how to finally dispose of them.

Hydroelectric generators are known, but require that the facility be physically in the path of moving water, such as rivers and tides. They also require large capital investments to build structures such as dams. Dams and underwater turbines also have the effect of changing the eco system or navigation lanes.

Accordingly, an energy source which overcomes the shortcomings of the prior art is desired.

### BRIEF SUMMARY OF THE INVENTION

A closed system column generator includes a container for holding a fluid therein. A traveler reciprocally travels between a first end of the container and a second end of the container through the fluid. At least one generator is disposed within the container adjacent the travel path of the traveler and converts motion of the traveler along the path to electricity.

In one embodiment, the generator includes a wheel for contacting the traveler as the traveler moves along the travel path. The motion of the traveler rotates the wheel. The traveler is a piston capable of being negatively, positively or neutrally buoyant as it travels along the travel path.

### BRIEF DESCRIPTION OF THE DRAWINGS

The present disclosure is better understood by reading the written description with reference to the accompanying drawing figures, in which like reference numerals denote similar structure and refer to like elements throughout in which:

FIG. 1 is a schematic view of a column generator constructed in accordance with the invention;

FIG. 2 is a sectional schematic view of a column generator constructed in accordance with the invention; and

FIG. 3 is a top plan sectional schematic view of the column generator constructed in accordance with a second embodiment of the invention.

### DETAILED DESCRIPTION OF THE PREFERRED EMBODIMENTS

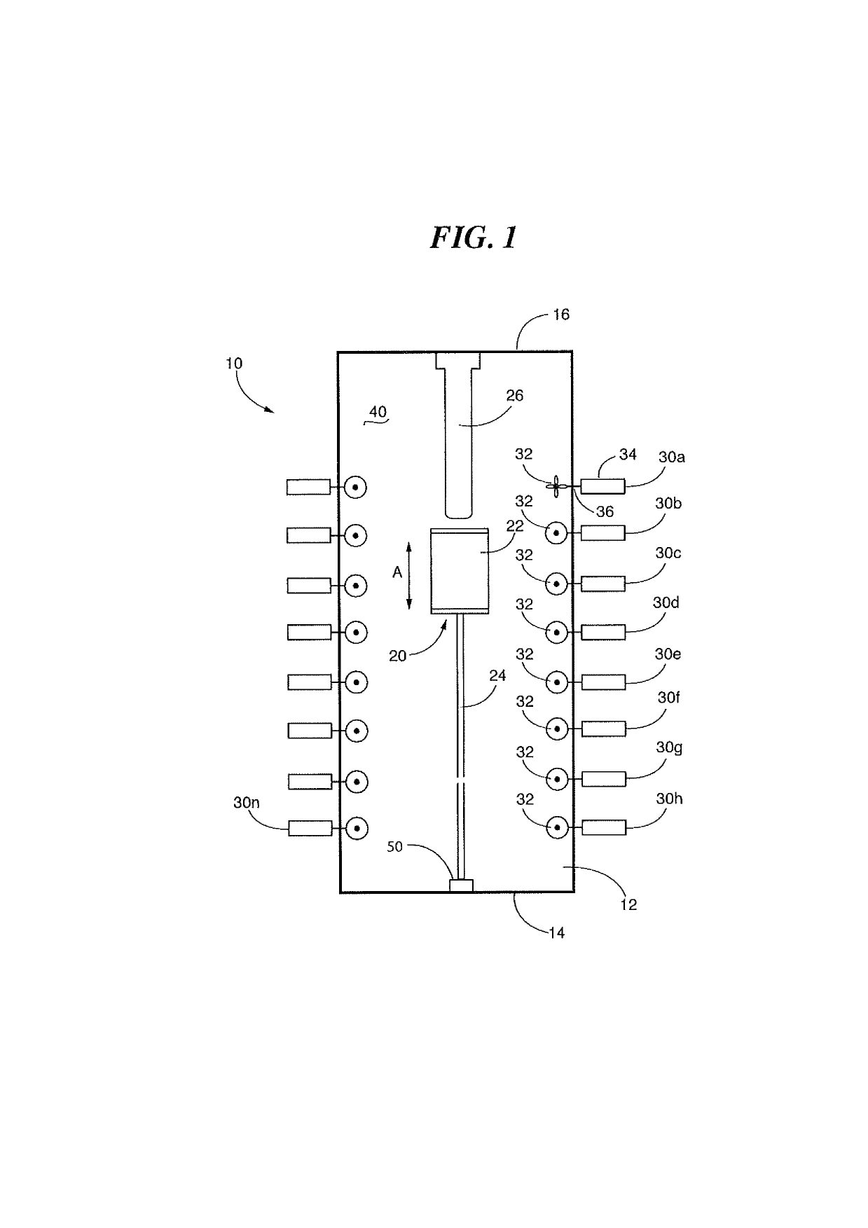

Reference is made to FIG. 1 in which a column generator, generally indicated as 10 includes a container 12. Container 12 holds a fluid 40 therein.

A traveler assembly 20 is disposed within container 12 and includes a traveler 22 capable of reciprocal movement in the directions of arrow A along a travel path between a first end 14 and second end 16 of container 12. Traveler assembly 20 includes a travel guide 24 disposed along at least a portion of the travel path and a static shaft disposed at one end of container 12.

Traveler 22, as will be discussed in greater detail below is disposed about travel guide 24 in a non-limiting embodiment. In a preferred embodiment, container 12 is completely filled with fluid 40; preferably water. Traveler 22 is capable of exhibiting negative buoyancy, positive buoyancy, and neutral buoyancy relative to fluid 40 through mechanical mechanisms as known in the art. Generators 30 are disposed at least partially within container 12 along the travel path of traveler 22 and are operatively connected to traveler 22 to generate electricity in response to movement of traveler 22 as traveler 22 is in the proximate area of respective generators 30a-30n.

Each generator 30 includes a mechanical actuator member 32 which undergoes motion in response to movement of fluid 40 as a result of moving traveler 22. By way of example, in a preferred embodiment as shown in FIG. 1, actuator 32 may be a flywheel having blades. As traveler 22 moves through container 12, traveler 22 displaces water along the travel path. The motion of the displaced water at generator 30 rotates the fins of flywheel actuator 32.

Actuator 32 is mechanically coupled to an electric generator 34 by a mechanical means such as gearing or a shaft 36. Electric generator 34 is a device which converts mechanical movement into electricity as known in the art, such as a rotor and stator electro-generator, a power turbine, piezo-electric conversion or the like by way of nonlimiting example.

A single generator 30 is sufficient to produce electricity. However, two or more generators 30 may be located around the entire circumference of container 12 to maximize power generation.

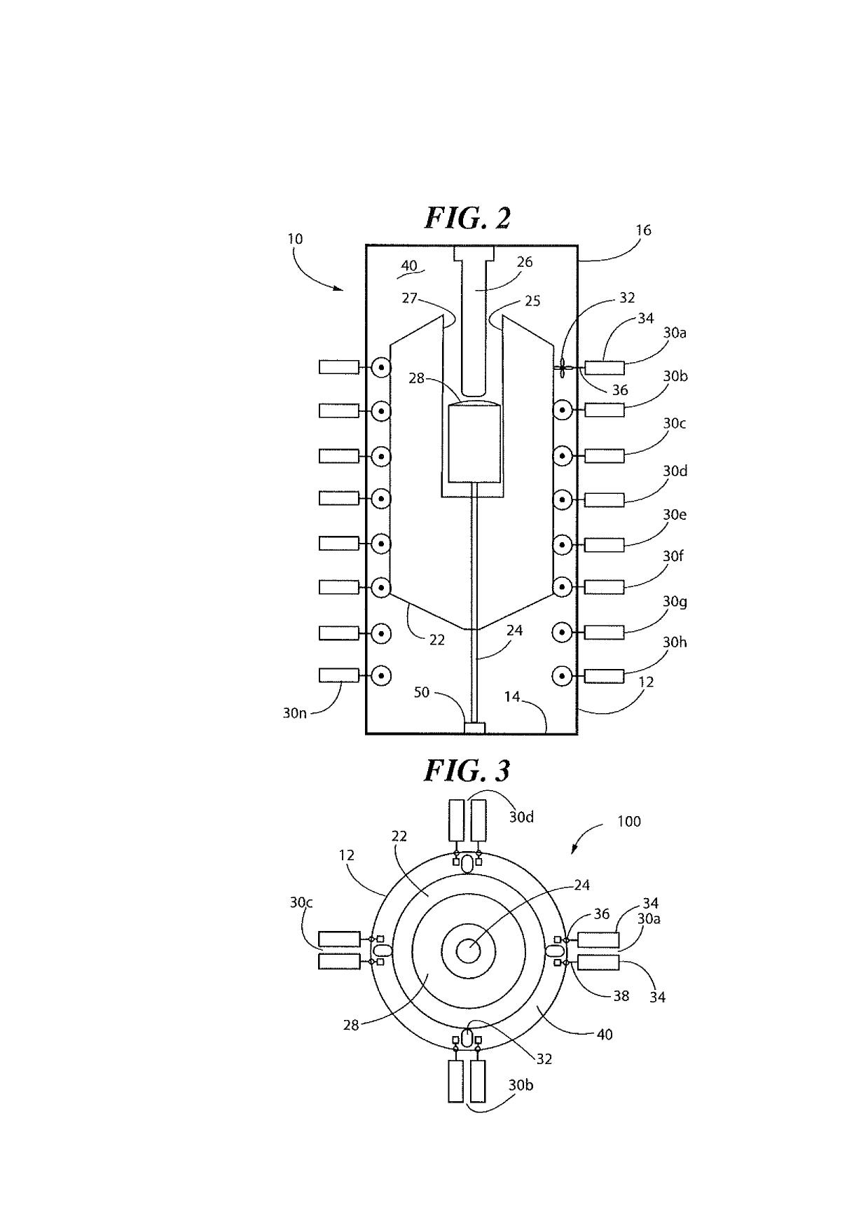

Reference is now made to FIG. 2 in which an enlarged sectional view of column generator 10 is provided. Traveler 22 is hollow or partially hollow and may contain an open ended piston chamber 27 formed within traveler 22. A piston 28 is disposed and moveable within piston chamber 27. As can be seen, traveler 22 is disposed about travel guide 24. In the preferred embodiment, traveler 22 has a positive buoyancy relative to fluid 40 within the column formed by container 12.

Traveler 22 moves within the column by changing the buoyancy of traveler 22 relative to fluid 40 causing traveler 22 to first move in the direction of arrow A towards a first end 14 of column 12 “sink” and then to “rise” within the column of fluid 40 in the direction of arrow A towards end 16. As discussed briefly above, the relative movement of traveler 22 within the column of fluid 40 actuates generators 30 arranged along the travel path of traveler 22 to cause generation of electrical energy by generators 30.

More specifically, traveler 22 travels in the direction along the travel path towards end 16. As traveler 22 approaches end 16, static shaft 26 enters the open end of piston chamber 27 and in effect pushes piston 28 down into chamber 27 as actuator arises towards the top of the column allowing fluid 40 to enter chamber 27 creating a relative negative buoyancy for traveler 22. The relative negative buoyancy causes traveler 22 to “sink”, i.e., move towards the opposed end 14.

Traveler 22 displaces fluid 40 as it passes a respective generator 30a-30n, the displaced fluid causes actuator 32 to move. Movement of actuator 32 causes electrical generator 34 to produce electricity. This production continues at each generator 30a-30n in series as traveler 22 moves along the travel path indicated by arrow A towards first end 14 of container 12.

As a result of the piston action of piston 28 moving within chamber 27, as traveler 22, moves in the direction of container end 14, piston 28 moves towards the open end 25 of chamber 27. Fluid 40 is forced out of chamber 27 so that traveler 22 exhibits positive buoyancy when it is positioned near end 14. This causes traveler to “rise” within fluid 40 along the travel path. Again, traveler 22 displaces fluid 40 as it travels towards end 16 causing movement of actuators 32 to create the electricity as discussed above.

It should become apparent, that the rate of rise and energy needed to move within the column of fluid 40 is a function of the volume of traveler 22 relative to the volume of fluid 40, the viscosity of fluid 40, and the overall buoyancy of the members of traveler assembly 20. Piston 28 is always relatively positively buoyant within fluid 40 such that it always wants to rise to the top of piston chamber 27 where it is prevented from escaping beyond the open end by a mechanical restraining means such as a leash, a barrier at the open end of chamber 27, or the like. As piston 28 rises towards the open end of piston chamber 27, piston 28 pushes water from chamber 27 to create an empty cavity within chamber 27 so that traveler 22 exhibits a positive buoyancy within fluid 40. It should be noted, that as traveler 22 travels along the travel path it's buoyancy relative to fluid 40 changes from negative to positive and back again. At some point there is a neutral transition point. The momentum of the moving traveler assembly and the action of piston 28 causes traveler 22 to move through the transition point to change buoyancy to either a negative or positive buoyancy. In this way, the traveler 22 does not stop along travel path 24 other than to reverse direction.

It should be noted, that a resilient member 50 may be placed at an end of the travel path which is opposite to the end of the travel path at which the static shaft 26 resides. In this way, as traveler 22 completes its travel along the travel path towards end 14, it is given an initial force in the opposite direction for the return trip towards end 16 to overcome any inertia. In an alternative embodiment of the invention, some additional force may be needed, or desirable, to assist traveler 22 in its movement within the column of fluid 40 to overcome the inertia of the traveler 22 and fluid 40, or frictional forces inherent in the fluid 40, to facilitate movement in either direction along the travel path. Furthermore, it may be desirable to include a pump, or vacuum assist, within the traveler 22 to expel fluid during travel, or admit fluid into traveler 22 to alter buoyancy of traveler 22 relative to the column of fluid 40. The power for this pump can be supplied from electricity generated by generators 30. With a sufficient number of generators 30, there would be still be a positive net generation of electricity by system 10.

It becomes apparent from the operation of piston 10, that container 12 is oriented so that the column of fluid 40 is a vertical column and container 12 is static. However, in another contemplated embodiment of the invention, container 12 need not be vertical, and movement of traveler 22 may be assisted or accomplished by movement of container 12 and the column of fluid 40 contained therein on a fulcrum such that container 12 exhibits “see-saw” movement. Thus when the orientation of column of fluid 40 changes relative to the horizon, a positive buoyant traveler 22 will move to the higher or a raised end of the column.

Reference is now made to FIG. 3 in which a system 100, constructed in accordance with a second embodiment of the invention is provided. Like numerals are utilized to indicate like structure, the primary difference being that actuator 32 is shown as a geared wheel which physically contacts traveler 22 as traveler 22 moves along the travel path to cause rotation of the geared wheel. Reference is made to Generator 130a which is exemplary of the remaining generators. Generator 130a includes a wheel 136 disposed within container 12 so as to come into contact with traveler 22 as traveler 22 moves adjacent generator 130a. As traveler 22 passes wheel 130a, wheel 130a rotates at least while in contract with traveler 130a. Generator 130 includes power generators 134 which mechanically coupled to wheels 132 by two or more geared shafts 136 capable of transmitting the rotational energy of wheel 132 to electric generators 134. Accordingly, a plurality of generators 138a-130d are disposed at least partially within container 12.

It should be understood, that it is well within the concept of the invention, that actuators 32 may be mechanically or induced actuators; in other words, may directly come in contact with traveler 22 or may be actuated by the affect of traveler 22 which is displacement of the water, i.e., the fluid 40 is a medium for operatively connecting traveler 22 to actuators 32. As a result, the actuators 32 need not physically contact traveler 22 in order to generate electricity. It is preferred that the profile of the traveler approximates the cross-sectional profile of the fluid pathway to maximize the number of generators 30 which may be disposed about the column of fluid 40 within container 12. By providing the closed system as described above, a sustainable energy source which overcomes the shortcomings of traditional fossil fuels and other hydroelectric generators is provided. By making the system a closed system, the column generator as described above is portable and may be used in almost any environment in which the ambient temperature is higher than the freezing point of the fluid contained within the container.

Thus, while there have been shown, described and pointed out novel features of the present invention as applied to preferred embodiments thereof, it will be understood that various submissions and substitutions and changes in the form and detail are contemplated to the disclosed invention, which may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention described and all of the statements of the scope of the invention which, as a matter of language, might be said to fall therebetween.

1. A closed system column generator comprising:
a container having a first end and a second end;
a traveler reciprocally travels along a travel path between the first end and the second end of the container, the traveler exhibiting positive buoyancy and negative buoyancy as a function of a position and direction of travel along the travel path; and
at least one generator disposed along the travel path, operatively connected to the traveler, to generate electricity as a function of movement of the traveler along the travel path at a position proximate to the generator.

2. The closed system column generator of claim 1, wherein the at least one generator includes a mechanical actuator which moves in response to movement of a fluid, and electricity generator mechanically coupled to the actuator for converting movement of the mechanical actuator to electric energy.

3. The closed system column generator of claim 2, wherein said actuator is a rotor.

4. The closed system column generator of claim 2, wherein said actuator is a wheel, the wheel contacting the traveler when the traveler is adjacent the generator along the travel path, the traveler rotating the wheel.

5. The closed system column generator of claim, further comprising a travel guide disposed within the container and extending along the travel path, the traveler traveling along the travel guide.

6. The closed system column generator of claim 5, wherein said traveler receives the travel guide therein.

7. The closed system column generator of claim 1, wherein the traveler includes a piston chamber and a piston disposed therein, movement of the piston within the piston chamber causes the traveler to exhibit one of positive buoyancy and negative buoyancy.

8. The closed system column generator further comprising a static shaft disposed at the second end of the container, the static shaft being sized to extend into the piston chamber as the traveler approaches the second end.

9. The closed system column generator of claim 8, wherein the static shaft deflects the piston within the piston chamber to induce a negative buoyancy in the traveler.

10. The closed system column generator of claim 1, further comprising a resilient member disposed along the travel path at the first end.
